(19) United States
(12) Patent Application Publication
(10) Pub. No.: US 2026/0247421 A1
(43) Pub. Date: Aug. 20, 2026

(54) METHOD AND SYSTEM FOR DYNAMIC SPECTRUM SHARING

(71) Applicant: Booz Allen Hamilton Inc., McLean, VA (US)

(72) Inventors: Michael Wayne Jacobs, Annapolis, MD (US); Awais Khawar, Bethesda, MD (US); Andrew Bolka, Charleston, SC (US); Yasaman Bahreini, San Diego, CA (US)

(73) Assignee: Booz Allen Hamilton Inc., McLean, VA (US)

(21) Appl. No.: 19/540,008

(22) Filed: Feb. 13, 2026

Related U.S. Application Data
(60) Provisional application No. 63/758,857, filed on Feb. 14, 2025.

(51) Int. Cl. H04W 72/541; H04W 72/0453

(52) U.S. Cl. CPC H04W 72/541; H04W 72/0453

(57) ABSTRACT

Exemplary systems and methods provide for mitigating interference on a radio network. An interface can receive spectrum usage data, incumbent system data, and RF network performance data from plural remote systems. A processor analyzes the received data to determine one or more sensor functions to at least one of activate and deactivate. The processor receives sensor data from one or more active sensors associated with received data and determines whether an incumbent system can be matched to a specified RF signal of the sensor data. The processor generates at least one of an RF network command, a sensor command, and an operator message based on the determination to control the usage of a specified frequency by one of the incumbent system and a non-incumbent system.

### RELATED APPLICATION

This application claims priority to U.S. Patent Application 63/758,857 filed on Feb. 14, 2025, the entire content of which is hereby incorporated by reference.

### FIELD

The present disclosure relates to systems and methods for signal processing, and more particularly for mitigating interference on a radio network.

### BACKGROUND

Known neural network radio network systems operate by collecting data from a wide array of sources, including organizational systems, sensors, network endpoints, and external data feeds. Once collected, the data undergoes preprocessing steps such as feature extraction, normalization, embedding generation, and transformation into analysis-ready formats. Metadata and contextual information are incorporated into the data, providing a comprehensive view of operational conditions. The platform employs layered machine learning models to analyze the data, identify patterns, detect anomalies, and uncover correlations. These models are continuously trained and refined through feedback mechanisms, allowing the system to adapt dynamically to evolving operational environments.

### SUMMARY

An exemplary method for mitigating interference in a radio network is disclosed, the method comprising: receiving, by an interface, spectrum usage data, incumbent system data, and RF network performance data from plural remote systems; analyzing, by a processor, the received data to determine one or more sensor functions to at least one of activate and deactivate; receiving, by the processor, sensor data from one or more active sensors associated with received data; determining, by the processor, whether an incumbent system can be matched to a specified RF signal of the sensor data; and generating, by a processor, at least one of an RF network command, a sensor command, and an operator message based on the determination to control the usage of a specified frequency by one of the incumbent system and a non-incumbent system.

A system for mitigating interference in a radio network is disclosed, the system comprising: memory configured to store programming code for controlling spectrum usage among incumbent and non-incumbent systems; a processor configured to execute the programming code stored in memory, the programming code causing the processor to be further configured to: receive spectrum usage data, incumbent system data, and RF network performance data from plural remote systems; analyze the received data to determine one or more sensor functions to at least one of activate and deactivate; receive sensor data from one or more active sensors associated with received data; determine whether an incumbent system can be matched to a specified RF signal of the sensor data; and generate at least one of an RF network command, a sensor command, and an operator message based on the determination to control the usage of a specified frequency by one of the incumbent system and a non-incumbent system.

### DESCRIPTION OF THE DRAWINGS

The scope of the present disclosure is best understood from the following detailed description of exemplary embodiments when read in conjunction with the accompanying drawings. Included in the drawings are the following figures:

FIG. 1 illustrates a system architecture in accordance with an exemplary embodiment of the present disclosure.

FIG. 2 illustrates an RF sensing architecture in accordance with an exemplary embodiment of the present disclosure.

FIG. 3 illustrates a data analysis architecture in accordance with an exemplary embodiment of the present disclosure.

FIG. 4 illustrates interfaces for remote data sources in accordance with an exemplary embodiment of the present disclosure.

FIGS. 5A and 5B illustrate a deep learning neural network in accordance with an exemplary embodiment of the present disclosure.

FIG. 6 illustrates a hardware configuration of a computing device in accordance with an exemplary embodiment of the present disclosure.

FIG. 7 illustrates a method for mitigating interference in accordance with an exemplary embodiment of the present disclosure.

Further areas of applicability of the present disclosure will become apparent from the detailed description provided hereinafter. The detailed descriptions of exemplary embodiments are intended for illustration purposes only and are, therefore, not intended to necessarily limit the scope of the disclosure.

### DETAILED DESCRIPTION

Exemplary embodiments of the present disclosure are configured to provide a decision making and command word generation for controlling interference mitigation methods in a radio network. An exemplary system can include plural sensors, and a computing system configured with a trained AI/ML model for processing radio signals to identify specific waveforms and specified characteristics of the radio signal. The plural sensors can include physical sensors deployed at specified locations in the network and virtual sensors using known radio network resources. The system can receive radio signal measurement information from other in-network radio resource data sources and network key performance indicators. The system can also receive data identifying incumbent systems, mission planning, GFE sensor data commands interference mitigations to the network based on available sensor capabilities. The system can also receive information and data concerning PRB blanking, beam muting, power reduction, frequency changes, and any other suitable information related to sensors, incumbent systems, radio network allocation, and usage as desired. The system can determine whether an identified waveform or observed event deserves protection from interference and can send instructions to a radio network to initiate or terminate interference mitigation.

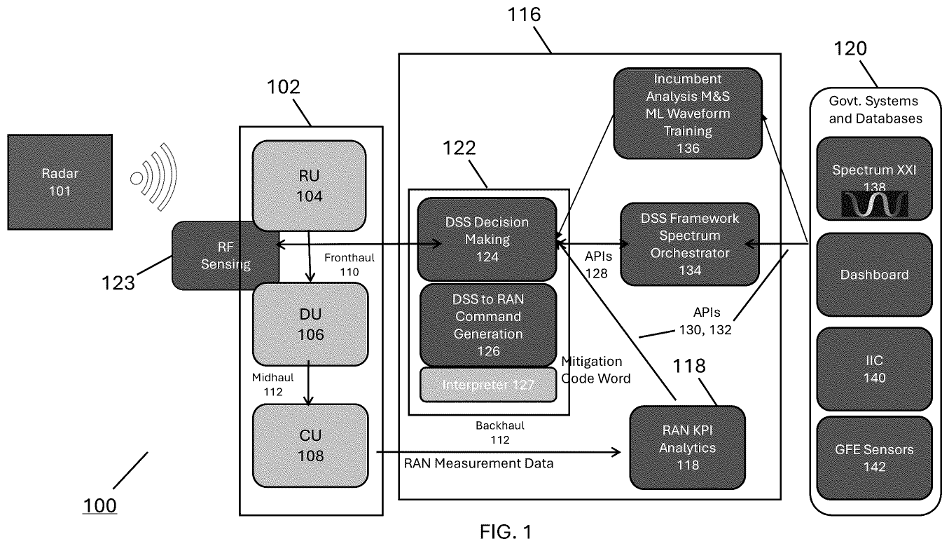

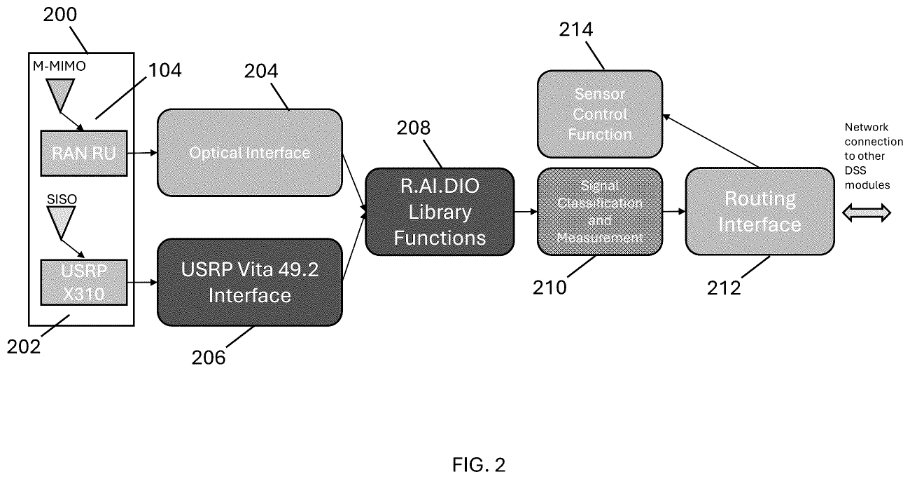

FIG. 1 illustrates a system architecture in accordance with an exemplary embodiment of the present disclosure. As shown in FIG. 2, the system 100 can include a radio access network 102 including a radio unit (RU) 104, a distributed unit (DU) 106, and centralized unit (CU) 108. The RAN 102 is part of a wireless telecommunications system and can include base stations that have antennas, radio units, and controllers that connect devices such as a mobile phone, a computer, or any remotely controlled machine, to other parts of the network through a radio link. When a device is connected to the RAN, it is the base station's job to transmit the device's traffic (voice, data, video) to the service provider's core network (CN).

The RU 104 can be connected to or be integrated with an antenna. The RU 104 can be configured to perform transmission, reception, amplification, and digitization operations of RF signals in combination with the antenna. For example, the RU 104 serves as an interface between user devices and the DU 106 and CU 108 and can be configured to communicate with the DU 106 via a fronthaul interface 110. The fronthaul interface 110 can separate radio signal processing (baseband) from the antenna and can communicate signal data using protocols, such as, include Common Public Radio Interface (CPRI), enhanced CPRI (eCPRI), and the Open Radio Access Network (O-RAN) fronthaul specification. The RU 104 can convert RF signals received from the antenna (e.g., radar) 101 to digital signals for communication to the DU 106 over the fronthaul interface 110.

The DU 106 can be connected to interact with the RU 104 via the fronthaul interface 110. The DU 106 can be configured to perform Medium Access Control (MAC), Radio Link Control (RLC), and manages scheduling. The DU 106 is connected to communicate with the CU 108 over a midhaul interface (F1) 112. The midhaul interface 112 can communicate signals using separate protocols for control (F1-C) and user planes (F1-U) over an IP transport layer.

The CU 108 is connected to communicate with the DU 106 and is configured to handle communication protocols like Radio Resource Control (RRC) and Packet Data Convergence Protocol (PDCP). It manages multiple DUs, controlling user data and mobility. The CU 108 is connected to communicate with the core network 116 over a backhaul interface 114. The backhaul interface 114 is configured to transport user data and signaling traffic from the edge to the core network 116.

The core network 116 can include one or more processors configured to run machine learning (ML) and/or artificial intelligence (AI) models trained for monitoring the RF spectrum for unlicensed interferers and tracking and mitigating in-band interferers that may degrade mobile network operator (MNO) performance with unauthorized transmissions in licensed spectrum. According to an embodiment, the core network 116 can ML/AI models to identify 5G, 6G, or other signals as desired and potential interference. The core network 116 can be connected to receive the RAN measurement data from the CU 108 and perform RAN Key Performance Index (KPI) analytics 118. Further the core network 116 can be connected to and configured to leverage plural data sources and/or information from third-party databases (e.g., government, industry, civilian, or other sources as desired) external to the 5G network or Dynamic Spectrum Sharing (DSS) system 120, and information and control messages from other third-party systems used by the government to manage its spectrum operations as well as to perform the role of an Incumbent Informing Capability (IIC). If interference is detected, the signal is isolated from 5G signals by utilizing a filter to remove known frequencies, leaving the interfering signal for further characterization. The interference can be isolated from the underlying 5G signal using FRESH (frequency shift filtering), fast independent component analysis (FastICA), or another suitable filtering method. A direction-finding algorithm MUSIC (multiple signal classification) can be used to determine the direction of the interference. The core network 116 can include an extended Kalman filter (EKF) is employed to track the location of the interfering signal.

As shown in FIG. 1, the one or processors of the core network 116 can be configured to include a RAN intelligent controller (RIC) 122 configured to manage the distribution and use of radio resources so that network slices can be shared among operators, or between government and commercial users. The RIC 122 can be configured to run one or more ML/AI models for performing DSS Decision Making Module 124 and DSS to RAN Command Generation operations 126. An interpreter 127 can be configured as a natural language interface for generating commands, perform calculations, analyze data, or generating charts based on the data inputs. The RIC 122 can be configured to execute plural application program interfaces (APIs) 128, 130, 132 for obtaining information and/or data for use by the Decision-Making Module 124 in identifying 5G signals and potential interference. For example, APIs 128 and 130 can be used so that the DSS Decision Making Module 124 can communicate with a DSS Framework Spectrum Orchestrator 134 and the RAN Key Performance Indicators (KPI) Analytics 118. The core network 116 can also include an Incumbent Analysis ML Waveform Trainer (IAMLWT) 136 that is connected to the RIC 122 for providing Waveform Training to the AI/ML model of the Decision-Making Module 124. The IAMLWT 136 and the DSSFS Orchestrator 134 can be connected to external third-party systems and database, such as the DSS system 120. The connection of the DSSFS orchestrator 134 and the DSS system 120 can be made through an API 132. The DSS system 120 can provide data on incumbent systems and spectrum assignments (SFAF) and other data to support decision making. For example, the DSS system 120 can provide information on the incumbent signal spectrum 138, the IIC 140, and GFE sensor 142. The DSS system can also include a dashboard 144 for facilitating effective communication with the platform through the API 132.

FIG. 2 illustrates an RF sensing architecture in accordance with an exemplary embodiment of the present disclosure. As shown in FIG. 2, the RF sensing 123 can be configured to be connected to an RF front-end 200 that includes the RU 104 and plural physical RF sensors 202. The RU 104 can be configured to be connected to a wireless antenna 200 based on multiple-input, multiple output technology where multiple antennas are used to simultaneously send and receive multiple data streams. According to an embodiment, the RU 104 can be configured to use spatial multiplexing to send different data streams in parallel or spatial diversity to send the same data across multiple paths for redundancy. The RU 104 can perform one or more operations on the received RF signals including beamforming to adjust the phase and amplitude of signals and assign beam identifiers to each signal.

The RF sensors 202 can include software-defined radios, such as universal software radio peripheral (USRP) devices. For example, the RF sensors 202 can have one or more programmable processors (e.g., field programmable gate array (FPGA)) configured for receiving 5G and/or 6G wideband signals (e.g., >1 MHz). The RF sensors 202 can be connected to provide output messages to a USRP interface 206. The USRP interface 206 can be configured to read and sort signal messages and extract desired IQ data and reformat the RF signals for compatibility with AI/ML functionality in the DU 106.

The RF sensing architecture can be configured to perform R.AI.DIO library functions 208 and Signal Classification and Measurement 210 on the receive RF signals, such as, analyzing complex samples from RF receivers to automatically identify areas containing known and unknown signals in real-time, identifying specific transmitters by comparing physical characteristics such as carrier frequency offset and phase noise, classifying signals using machine learning, which can help identify unauthorized users or malicious jammers, identifying conflicting signals in the spectrum (5G, 6G, and radar) and generating commands to reduce interference. The Signal Classification and Measurement 210 can be configured to determine if any signals detected can be matched to specific incumbent platforms. If a matching is not feasible, the classification module 208 can estimate whether it is more likely a valid incumbent deserving protection or an interferer that must be notified to network operator and regulators. The output of the classification module 208 is sent to a routing interface 212 configured to accept and route control messages from the classification module 208. For example, the routing interface 210 formats and sends signal classification and measurement data to DSS Decision Making module 120 or via the network to other modules and/or processors for action. The Decision-making module 120 can be configured for performing and/or activate a sensor control function 212 in which sensor functions can be controlled and activated or deactivated under command of the other DSS modules. Used to alert sensors to specific frequencies for detailed sensing.

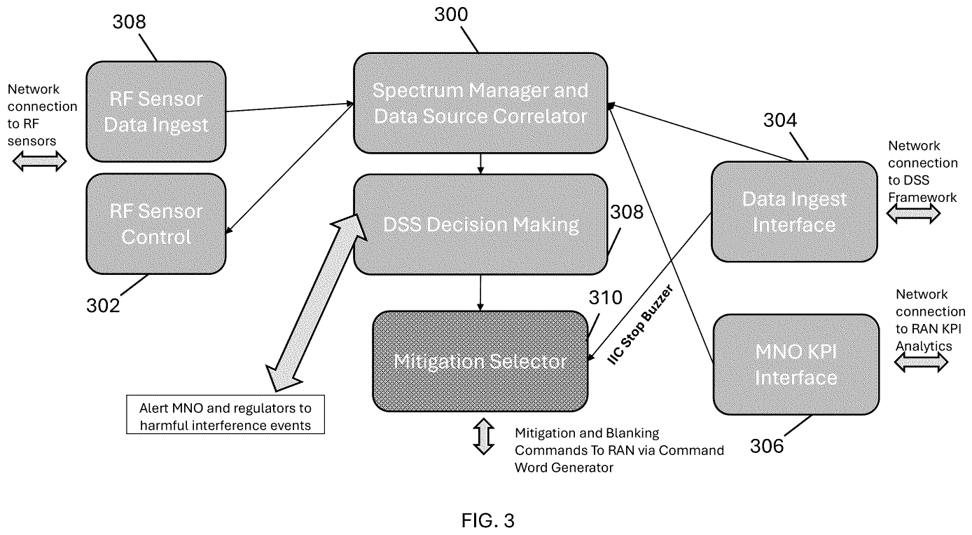

FIG. 3 illustrates a data analysis architecture in accordance with an exemplary embodiment of the present disclosure. As shown in FIG. 3, the RIC 120 can include a spectrum manager and data source correlator 300 that is configured to receive information from plural sources and provide an output to the RF sensing architecture 123 for performing RF sensor control 302. The data source correlator 300 can receive data from a data ingest interface 304. The data ingest interface 304 can be connected to the DSS system or framework 120 via a network connection and receive data on incumbent system and spectrum assignments. The data source correlator 300 can also be connected to a mobile network operator (MNO) KPI interface 306 for receiving key performance indicator data from a mobile network operator (MNO). The MNO interface 306 can be connected to RAN KPI analytics 118 of the core network 116. Further, the data source correlator 300 can be connected to the RF Sensing architecture 123 for receiving RF sensor data 308. The data source correlator 300 uses a trained ML/AI model to process the received data to correlate the received RF sensor data, with the incumbent signal spectral analysis information received from the DSS system 120, and the MNO KPI data to identify, classify, and correlate interfering signals in view of the incumbent signals. The result of the correlation is passed to the DSS Decision making module 308 where it is determined whether the signal spectrum of the RF sensor data is tied to a valid platform and if the platform is not valid whether a mitigating action is necessary. For example, when the platform is not valid the Decision-making module 308 can send an alert to the MNO and regulators that harmful interference events are occurring on the network within a specified RF frequency range. When mitigating action is necessary, the Decision-Making module 308 can send a signal to a mitigation selector 310. The mitigation selector 310 can receive the data from the Decision-Making module 308 and determine the type of mitigation response is appropriate. For example, the mitigation selector 310 can receive data from a third-party platform such as a government system, which has an incumbent informing capability. The mitigation selector 310 can receive the IIC signal from the third-party platform and determine that a stop buzzer command should be issued so that the offending party can immediately stop the interference generating activity.

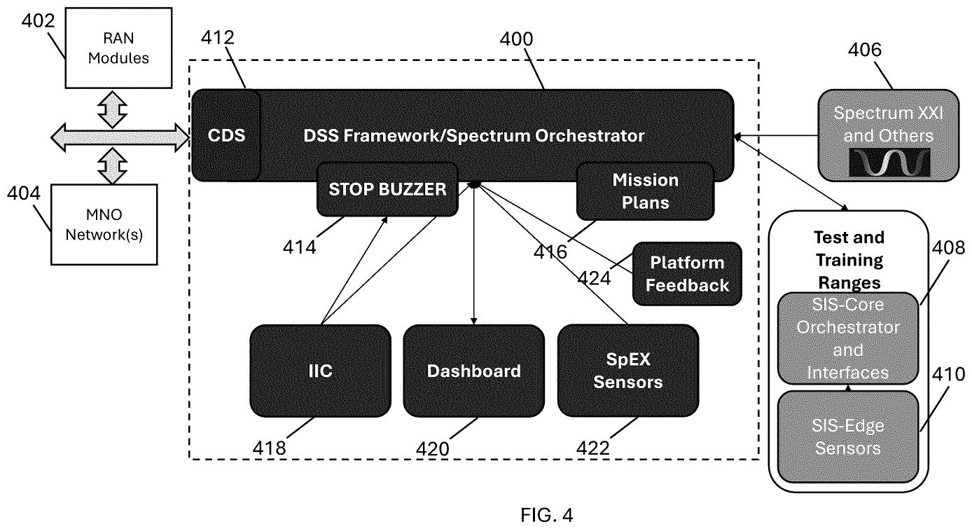

FIG. 4 illustrates interfaces for remote data sources in accordance with an exemplary embodiment of the present disclosure. As shown in FIG. 4, the DSS Framework/Spectrum Orchestrator 400 that centralizes operations related to incumbent notifications, stop buzzer control, and GFI database interfaces. The orchestrator 400 can be connected to for communication with other RAN DSS modules 402, such as the RIC 120, and plural in band MNO networks 404. The orchestrator can also be connected to communicate with third-party/government databases 406 which provide data on incumbent systems and spectrum assignments and other data to support decision making. In addition, the orchestrator 400 can be connected to one or more interfaces 408 and edge sensors 410 for communicating with known systems designed for advanced electromagnetic spectrum (EMS) management. These systems can include Operational Spectrum Comprehension, Analytics, and Response (OSCAR) that provides near-real time, automated orchestration for spectrum management, and Multiband Instrumented Control Channel Architecture (MICCA) that includes a radio architecture for managing spectrum access across multiple bands.

According to an exemplary embodiment, the orchestrator 400 can include a cross-domain module 412 that provides alternative solutions and methods for managing functions/operations which have information protected by a security classification. The orchestrator 400 can be configured to generate a stop buzzer signal 414 and mission plans 416. The stop buzzer 414 can be configured to provide emergency control of spectrum access for national security events, limited control (e.g., NORAD EADS, WADS). The mission plans 416 can include one or more documents that outline specific goals, methods, and steps necessary for implementing a strategic and actionable plan to achieve for a specific purpose. The orchestrator 400 can be configured to use the mission plans 416 for automating IIC functions for planned missions. The orchestrator can be further configured to include an incumbent informing capability (IIC) 418, a dashboard 420, special purpose (SpEX) sensors 422, and platform feedback interface 424. The IIC 418 can provide routine control of spectrum access for planned test/training events and LPI/LPD coexistence. The dashboard 420 provides an interface for mission planning and spectrum situational awareness to users. The SpEX sensors 422 can be deployed for limited use for specific missions. The platform feedback interface 424 can be configured to collect, organize, analyze, user insights of the orchestrator 400 and associated operations/functionality. The feedback interface 424 can provide a mechanism for updating the platform and/or platform features for improving the operation and/or user experience.

According to an exemplary embodiment, the system receives technical information and/or data on incumbent systems and a 3GPP network. The received information/data is analyzed using the trained AI/ML models to determine interference thresholds and metrics for determining spectrum allocation and/or sharing. Based on the analysis, the system can define incumbent waveforms that require protection and actives one or more sensors recognize specific waveforms for OTA detection and characterization. Data such as incumbent spectrum usage can be used to identify geographic areas and specific frequency sub-bands for which mitigation can be implemented by planning. The system can receive mission planning information such as activations in-band and IIC events initiated by an entity and GFE sensor data form SIS-Edge/Core or other system at test and training ranges. The system can further obtain and/or receive cueing data on possible interference events from 5G RAN KPI monitoring and act on the received data by initiating mitigation or activating sensors to confirm and obtain more accurate data. For example, the sensors can be activated to obtain data in specific areas related to the incumbent systems or radio spectrum associated with an incumbent system. Commands can be sent to a 5G network to monitor network compliance, monitor unauthorized activity, and notify operators based on the monitoring results.

In one example, a wideband RF spectrum of 100 MHz can be captured by a wireless receiver operating in a busy environment with multiple coexisting signals. The receiver's antenna captures RF signals transmitted by several devices operating simultaneously, including a long-term evolution (LTE) transmission at around 2.4 GHz, a Wi-Fi signal nearby at approximately 2.44 GHz, and a Bluetooth-like GFSK signal around 2.45 GHz. The RF front-end processes these signals, performing frequency translation, filtering, and amplification before the analog-to-digital converter (ADC) digitizes the IQ data streams—namely, the I (In-phase) and Q (Quadrature) components —each comprising 4096 data points.

The digitized IQ data then undergoes spectrum analysis through an FFT-based process. A 4096-point FFT transforms the time-domain IQ samples into the frequency domain, revealing peaks at the respective center frequencies of the signals. From this spectrum, the system extracts signal analytics such as the center frequencies (approximately 2.4 GHz, 2.44 GHz, and 2.45 GHz), estimated bandwidths (around 20 MHz for LTE and Wi-Fi, about 2 MHz for Bluetooth), and power levels (for instance, −45 dBm, −50 dBm, and −60 dBm). These analytics help identify the presence and spectral extent of each signal within the overall bandwidth.

The system can acquire the information such as receive data on incumbent system and spectrum assignments, mission plans, an incumbent informing capability, RAN KPI analytics. The system can perform an analysis on the incumbent signals and AI/ML training on the various waveforms.

Next, the spectrum search algorithm detects peaks and segments the wideband spectrum into slices tailored to each identified signal. These slices are around their estimated center frequencies and match their bandwidths. Each spectral slice is isolated, and an inverse FFT (IFFT) reconstructs the time-domain waveform for each signal, focusing on its spectral region. The process also involves translating each reconstructed signal to a common center frequency, which simplifies subsequent analysis.

Once isolated and reconstructed, the signals are input into a neural network trained to classify modulation types. For the LTE signal, the neural network might determine that it uses 16-QAM modulation, with characteristics such as a 20 MHz bandwidth, a power level of approximately −45 dBm, and a high signal-to-noise ratio (SNR) of around 30 dB, indicating good channel quality. The Wi-Fi signal could be classified as a 64-QAM OFDM modulation, occupying roughly 20 MHz bandwidth, at a power level of −50 dBm, with moderate SNR of about 20 dB, suggesting the presence of multipath effects. The Bluetooth-like signal may be identified as GFSK modulation, with a narrow 2 MHz bandwidth, at −60 dBm power, and an SNR around 10 dB, implying a relatively weak interference-affected signal. Further aspects of signal classification are described in U.S. Pat. Nos. 10,944,440, 11,509,339, and 11,764,817 which are hereby incorporated by reference in their entirety.

Beyond classification, the system 100 performs further signal characteristic analyses using the information received from the government and civilian sources. For example, the system can compute power spectral densities, refine bandwidth estimations based on spectral bounds, and assess channel impairments such as error vector magnitude and multipath distortion. The system can also detect interference levels, especially if spectral overlaps or power discrepancies indicate potential conflicts between signals. In one example, the received information/data is analyzed using the trained AI/ML models to determine interference thresholds and metrics for determining spectrum allocation and/or sharing, incumbent waveforms that require protection are identified, and operations such as activating one or more sensors recognize specific waveforms for OTA detection and characterization can be implemented. Further, specific geographic areas and frequency sub-bands can be identified for which mitigation can be implemented by planning. In another example, the system can use an IIC capability to issue a stop buzzer, which provides emergency control of spectrum access.

The comprehensive evaluation is assembled into a spectrum environment report. Such a report enables dynamic spectrum management, allowing the system to make intelligent decisions, like reducing transmission power, avoiding busy or interference-prone bands, or scheduling new transmissions in cleaner slices of the spectrum. This capability exemplifies the advantages of integrating neural networks into wireless receivers: rapid, robust detection and classification of multiple signals, simplified processing chains that reduce size and power consumption, and improved adaptability in complex, multi-user RF environments.

The system can include a deep learning neural network architecture that utilizes natural language processing and artificial intelligence to dynamically process data from plural sensors and plural remote data sources to control the usage of the specified RF signal by at least one of the incumbent system and a non-incumbent system for interference mitigation. The model(s) can be configured and/or trained to make decisions based on sensor data and various remote data sources. The model can also determine whether the received data is imperfect (e.g., incomplete) and determine how best to proceed with mitigation operation.

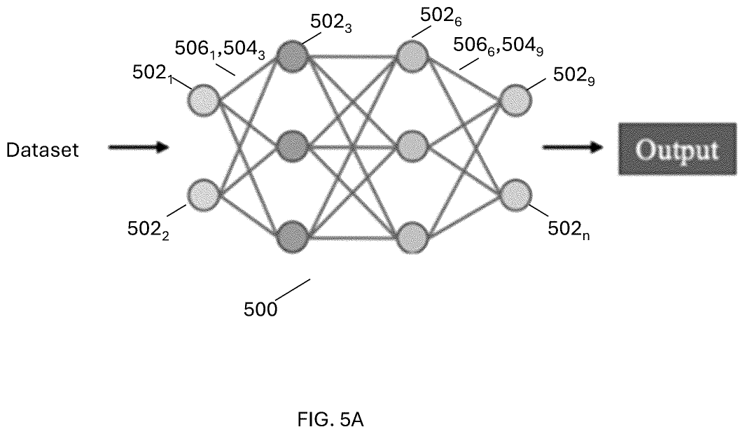

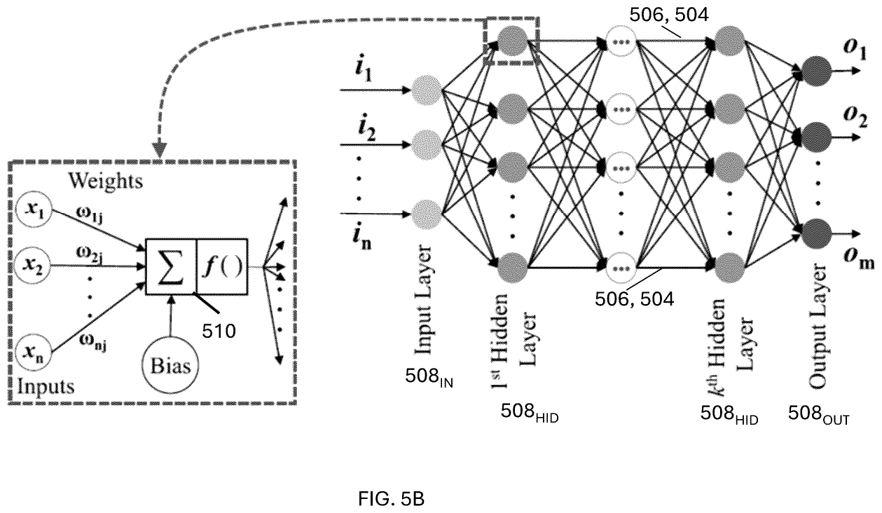

The neural network can include plural nodes that represent individual computational units. Each node has one or more biased input/output connections that function as transfer or activation functions for combining the inputs and outputs in a specified manner. As shown in FIG. 5A the neural network 500 includes plural nodes 502₁ to 502ₙ where each node 502ₙ has one or more inputs (i) 504 and outputs (o) 506 for processing the data. The neural network 500 is formed by an arrangement of the plural nodes 502ₙ into multiple layers 508, the scheme within which the nodes 502ₙ are connected determines the type and operation of the neural network 500. For example, as shown in FIG. 5B, the neural network 500 can include an input layer 508_{IN}N, multiple hidden layers 508_{HID}, and an output layer 508_{OUT}. Each layer 508 may perform a different or specified transformation on the respective inputs, using a different or specified mathematical calculation or function. Signals travel or are passed between the layers 508, from the input layer 508_{IL} to the output layer 508_{OUT} via the middle or hidden layers 508_{HID} and can traverse any layer 508 and node(s) 502 multiple times. As shown in FIG. 5B, the nodes 502ₙ can be connected in an array and each node can transmit a signal to a node in another layer 508 of the neural network 500. The input/output connections 504,506 between the nodes have a corresponding weight wₙⱼ and are combined according to the bias applied at each node. For example, the connections 504,506 are activation or transfer functions which trigger the respective nodes and combine inputs according to mathematical equations or formulas 510 according to the bias. According to these neural network principles, and as shown in FIG. 5B, the data is received at an input layer 508_{IN} of the neural network 500 and passed through multiple hidden layers 508_{HID} for generating a virtual training exercise on a physical platform. According to exemplary embodiments of the present disclosure, learning actions of the neural network can be achieved by feedback an output and updating of node weights based on the feedback. The neural network can be executed by the computing system and/or by an external or remote processing device accessible through the network. In one embodiment, using one or more trained models of the neural network architecture, the computing system can control the interference mitigation for a specified frequency used by an incumbent system based on the detected activity or likelihood of activity by a non-incumbent system.

The present disclosure describes a unique combination of data repositories as inputs, which in itself can be utilized to generate, train, and adapt AI/ML modeling for specific and practical purposes beyond what standard AI solutions provide. Above that, examples of the present disclosure may further transform data inputs to improve the training and usability of AI/ML modeling. For instance, inputs such as government databases such as SXXI/GEMSIS provide data on incumbent systems and spectrum assignments and other data to support decision making, mission plans, near-real-time, dynamic radio frequency spectrum access for military operations, and other data sources suitable for identify interfering signals, determine their general location, and understand their patterns, can be leveraged to build knowledge graphs or ontology for organizational rules and policies that can help improve data ingestion and processing by AI/ML modeling (e.g., setting fixed rules, parameters). This can greatly improve processing accuracy, results, and reduce error rates when dealing with high levels of complexity in processing efficiency, device control, resource allocation, and a very broad scope of data parameters to evaluate, thereby setting ground rules and adding valuable context for modeling to learn and adapt in a novel way. In further examples, AI/ML modeling may be uniquely constructed to include a fusion layer that bridges broad data inputs with organizational constraints and/or satisfaction conditions to best optimize placements within those constraints or satisfaction requirements. AI/ML modeling can also be utilized to create radio signal and sensor capability embeddings, which may be leveraged as created vectors to enhance interference detection and mitigation.

In some examples, exemplary AI/ML modeling can be built/generated, trained, and adapted for purposes disclosed here. For instance, AI/ML modeling may be utilized to generate data insights as justifications for interference detection and mitigation. This provides contextual insights into incumbent systems, spectrum assignments, sensor data, sensor commands, mission planning, RAN KPI data, etc., which can be used as a base layer to build novel, practical applications. In this way, the present disclosure provides an extensible and scalable solution applicable to a wide variety of practical applications. In one example, the present disclosure may include generating and maintaining a data insights data layer that can be integrated into a data platform to interface with other components, data layers, and other integrations (including third-party integrations such as CRMs), whereby the data layer acts as a building block to build a layered system architecture that provides not only a queryable data repository but also a valuable data endpoint for other services to integrate with. Some key non-limiting innovative aspects by which such contextual data insights are used in the present disclosure include:

Waveform distortion patterns or spectral signatures associated with interference can be quantified and incorporated as input features, enabling models to better distinguish between benign anomalies and malicious interference.

By integrating external data from civilian and government sources as described herein, the AI/ML model can gain contextual awareness, allowing for the adjustment of predictions based on known interference sources. This can reduce false positives during environmental interference events and improve the reliability of threat detection.

Analysis of interference patterns over time allows the system to adapt its alert thresholds dynamically. For example, during known interference periods, the model can lower its sensitivity to prevent false alarms, and conversely, raise thresholds when interference subsides, maintaining optimal detection performance.

Ability to adjust parameters of modeling (e.g., through admin GUI), such that supervisors can provide interference insights which can help in creating labeled datasets by identifying specific interference scenarios (e.g., jamming, electromagnetic noise). These labeled examples can be used to train supervised models, improving their ability to recognize various interference types. A GUI menu can also be used to provide insights into interference signatures enable the generation of synthetic training data that mimics interference conditions. The GUI can allow for data augmentation techniques which an simulate interference events, making models more robust against real-world interference tactics. For example, insights generated by these models support decision-making by detecting issues such as interference, security breaches, or operational inefficiencies. The GUI can also automatically recommend or initiate mitigation actions, adjust workflows, or alert operators to critical events. To facilitate user interaction, the system can generate intuitive dashboards and visualization tools that display real-time analytics, alerts, and operational metrics. Users can customize views, set thresholds, and manage AI/ML models to suit their specific needs.

Real-time interference data provides ongoing feedback for model retraining. When the system detects new interference patterns, these can be incorporated into the training dataset, allowing models to learn and adapt to evolving interference tactics, ensuring sustained accuracy over time.

By analyzing trends in interference data, the AI/ML model can predict the likelihood of future interference events or escalation, enabling preemptive mitigation actions. For example, if spectral analysis indicates increasing interference levels in certain bands, the system can proactively switch frequencies or activate countermeasures before communication degradation occurs.

The continuous feedback from interference detection can include knowledge of false positives/negatives, detection latency, or misclassification. This knowledge can be used to fine-tune hyperparameters, select optimal features, and refine model architectures. This iterative process ensures that the AI/ML models remain adaptive and resilient in dynamic environments.

Data insights may be generated and presented through a front-end applications/service. By analyzing the time-series waveforms of network traffic, the system disclosed herein can identify unusual distortions or anomalies indicative of interference. For example, sudden spikes or irregular fluctuations in signal amplitude, frequency, or phase may suggest jamming, signal spoofing, or electromagnetic interference. The AI/ML model can learn to recognize incumbent waveform signatures and flag deviations that could indicate interference, enabling targeted mitigation strategies. Spectral analysis of incumbent signals can reveal the presence of interfering signals operating within certain frequency bands. For instance, the detection of unexpected spectral peaks or broad-spectrum noise overlays can indicate intentional jamming or unintentional electromagnetic interference. These insights help in adjusting frequency hopping or channel switching algorithms to avoid compromised bands, thereby maintaining communication integrity.

The data insights can include elevated error rates, retransmissions, or packet loss, which deviate from established baselines. Monitoring these metrics over time can enable the AI/ML model to distinguish between benign network congestion and interference-induced disruptions, informing adaptive responses. Cross-correlation analysis of anomalies detected at multiple points in the network can help identify interference sources that have a broad or localized impact. For example, simultaneous waveform distortions across geographically dispersed nodes may indicate a widespread interference source, prompting targeted mitigation like rerouting or signal filtering. Incorporating environmental and/or mission data, such as electromagnetic spectrum scans, weather conditions, or known interference sources (e.g., nearby radio transmitters), can enhance the AI's understanding of interference contexts. This integration allows the model to differentiate between environmental interference and malicious jamming, optimizing mitigation actions accordingly.

AI/ML models analyze real-time signal data, network traffic patterns, and system logs to identify deviations from established compliance policies and operational standards. For example, models can detect anomalous traffic flows, unauthorized protocol usage, or unexpected changes in signal characteristics that violate governmental or regulatory standards. When such interference-like anomalies are identified, the system can automatically flag these events, ensuring ongoing adherence to compliance with the regulatory standards. By continuously analyzing network signals, user behavior, and system interactions, AI/ML models can identify patterns indicative of unauthorized access or malicious activity. This includes detecting unusual data exfiltration attempts, unauthorized device connections, or atypical communication patterns that could signal malicious interference. The models can adaptively learn from evolving threat signatures, improving detection accuracy over time.

Upon detection of potential violations or interference events, the system can automatically generate alerts, notifications, or reports tailored to operational needs. These notifications can be delivered via dashboards (GUIs), email, SMS, or integrated security information and event management (SIEM) systems. Furthermore, the system can prioritize alerts based on severity, suggest automated mitigation actions (such as blocking suspicious traffic or isolating affected network segments), and log events for audit and compliance purposes.

Spectral analysis as provided by the third-party and/or government platforms can provide detailed insights into the radio frequency environment, enabling more precise detection, classification, and mitigation of interference. Spectral analysis allows for high-resolution examination of the spectrum, helping to identify specific signal characteristics such as bandwidth, modulation type, and power levels. This enables the system to distinguish between legitimate military signals and malicious or unlicensed interference with greater accuracy. By analyzing the spectral signatures over time and across different frequency bands, spectral analysis can help pinpoint the exact location and source of interference or unauthorized transmissions. This spatial-temporal insight improves the effectiveness of mitigation strategies. Spectral analysis can inform adaptive filtering techniques that dynamically suppress interference without affecting legitimate signals. For example, if a certain frequency band is identified as compromised, the system can adjust its filters or reallocate spectrum resources in real time to maintain communication quality. Analyzing spectral data over extended periods can reveal patterns or emerging threats, such as coordinated jamming or spectrum hijacking attempts.

During real-time spectrum monitoring, the system can capture IQ samples across multiple frequency bands and the spectral analysis information obtained from external third-party and/or government platforms. The spectral analysis information can be used to generate detailed spectral signatures of the detected signals For example, the system can detect a sudden spike in energy within a narrow frequency band, accompanied by a specific modulation pattern characteristic of jamming signals. By analyzing the spectral shape, bandwidth, and power levels, the system can accurately differentiate between legitimate military communications and malicious interference. This detailed spectral information enables the AI models to classify the interference as a jamming attack and determine its source location more precisely. Consequently, the system can dynamically reallocate spectrum resources, filter out the interference, and alert operators with spectral maps showing the position of the interference source. This spectral analysis-driven approach enhances the system's ability to respond swiftly and accurately to spectrum threats, maintaining secure and reliable communication channels for military operations.

KPI metrics of mobile networks such as throughput, latency, packet loss, signal-to-noise ratio (SNR), and connection reliability provide quantitative indicators of network health. By continuously monitoring these KPIs, the system can detect deviations from normal performance that may indicate interference or other issues. When KPI thresholds are breached (e.g., a sudden drop in throughput or increased latency), the system can automatically initiate spectrum sensing and interference mitigation procedures. KPI data helps prioritize mitigation efforts. For example, if certain links or regions show a significant KPI decline, targeted spectrum analysis and mitigation can be focused there, optimizing resource use and minimizing impact on unaffected areas. KPI trends can be fed into the ML/AI models to improve their accuracy in detecting interference patterns, such as, a persistent drop in SNR coupled with increased packet loss can reinforce the identification of interference sources.

The system can continuously track KPIs such as throughput and latency for critical links, as received from MNOs. When a sharp decrease in throughput and an increase in latency in a specific sector is detected in the data via the spectral analysis information obtained by the spectrum orchestrator, can identify a narrowband jamming signal. Based on the KPI data, the system prioritizes mitigation in this sector, can dynamically reallocate spectrum resources, and apply filters to suppress the interference, and send notification such as a Stop Buzzer to the source mobile network. The integration of KPI insights into the analysis of ensures that interference mitigation is both targeted and effective, maintaining the network's operational integrity and situational awareness.

In any example described herein, artificial intelligence and/or machine learning (AI/ML) models may be employed to analyze input data and generate predictions, classifications, data insights, or recommendations. Furthermore, one or more management components may interface with AI/ML components to enable automated execution of tasks and actions to achieve practical applications described herein. As an example, a result generated by AI/ML modeling may be leveraged to trigger execution of automated decisions, raise inflection points, notifications, and modify process flow, among other non-limiting examples. Additionally, exemplary AI/ML modeling may further be integrated into a software data platform to enable data ingestion and connection to data endpoints and services which may feed critical and novel data (and metadata), including exemplary signal data, to AI/ML modeling for continuous processing. This can include continuous provision of feedback for enhanced training and adaptation of AI/ML modeling as well as various types of signal data described herein that can provide customized and novel real-time (near real-time) contextual analysis of integrated applications/services.

The AI/ML models described herein may include, without limitation, supervised learning models, unsupervised learning models, reinforcement learning models, deep learning neural networks, transformer-based architectures, ensemble models, or hybrid combinations thereof. Input data may comprise but is not limited structured, semi-structured, and/or unstructured data, and further comprise any type of record or documentation including but not limited to: numerical records, categorical data, textual data, audio, video, sensor data, network activity, web pages, documents, messages (e.g., text or chat), social media, historical project outcomes, knowledge graphs, and ontology. Preprocessing operations may include feature extraction, dimensionality reduction, normalization, tokenization, vectorization, embedding generation, and/or transformation into numerical representations suitable for model consumption. Non-limiting examples of types of data layers may comprise but are not limited to: raw data layers, pre-processing or clean-up layers, feature engineering or transformation layers, embedding layers (e.g., word embedding, node embeddings, latent learned features), model input layers, hidden or intermediate layers (e.g., neural network specific such as convolution layers, recurrent/temporal layers, transformer/self-attention layers), output or scoring layers (e.g., softmax, regression, ranking), post-processing layers (e.g., re-rank, weighting, filtering), and feedback or reinforcement layers (training and re-ranking based on collected signal data). Data layers may further incorporate metadata, contextual attributes, and/or weighting factors customized/defined by users including those derived from organizational data (e.g., guidelines, performance history, or user preferences).

Non-limiting examples of supervised learning that may be applied comprise but are not limited to: nearest neighbor processing; naive bayes classification processing; decision trees; random forests; gradient boosting; linear regression; support vector machines (SVM) neural networks (e.g., convolutional neural network (CNN) or recurrent neural network (RNN)); and transformers, among other examples. Non-limiting of unsupervised learning that may be applied comprise but are not limited to: application of clustering processing including k-means for clustering problems, hierarchical clustering, mixture modeling, other dimensionality reduction, etc.; application of association rule learning; application of latent variable modeling; anomaly detection; and neural network processing, among other examples. Non-limiting of semi-supervised learning that may be applied comprise but are not limited to: assumption determination processing; generative modeling; low-density separation processing and graph-based method processing, among other examples. Non-limiting of reinforcement learning that may be applied comprise but are not limited to: value-based processing; policy-based processing (policy gradient methods); and model-based processing, Q-learning, among other examples. Non-limiting examples of transformer models comprise but are not limited to: encoder-decoder architectures, attention-based mechanisms, and large language models (e.g., contextual embeddings, sequence-to-sequence learning), among other examples. Non-limiting examples of ensemble models comprise but are not limited to: combinations of classifiers or regressors (e.g., boosting, bagging, stacking), voting/aggregation (e.g., majority or weighted voting), Bayesian averaging, ensemble neural networks, snapshot ensembles, or dropout ensembles, among other examples.

Multiple AI/ML layers may be integrated, where a rules-based layer enforces hard constraints related to interference thresholds and operational safety limits, while a machine learning layer dynamically optimizes mitigation strategies within permissible solution spaces. Transformer-based embeddings can be combined with clustering methods to identify latent interference patterns within key data sets, such as signal metrics, environmental parameters, or system states. Graph-based models may represent relationships between entities such as sensors, communication channels, interference sources, and system components, capturing complex interdependencies. Reinforcement learning layers can be employed to adaptively optimize mitigation actions, such as adjusting signal parameters, reallocating resources, or reconfiguring system operations, through repeated simulations, thereby enhancing interference suppression and system resilience in real-time or near real-time scenarios.

In any AI/ML example, models are continuously trained and optimized to adapt and improve performance and accuracy. Training may comprise but is not limited to: forward propagation, backpropagation, gradient descent, stochastic gradient optimization, hyperparameter tuning, and/or automated model selection, or a combination thereof. Training datasets, validation datasets, and test datasets may be partitioned according to standard practices or dynamically adjusted based on input constraints. Loss functions may further be applied to minimize loss and improve accuracy. Loss functions may comprise but are not limited cross-entropy, mean squared error, hinge loss, cosine similarity, or domain-specific cost functions, among other examples. Weights, biases, and other parameters may be updated iteratively to minimize loss functions while maximizing predictive performance.

Additionally, AI/ML processing may include scoring, ranking, and weighting mechanisms to optimize mitigation actions and system responses. Model outputs may comprise raw prediction scores, probability distributions, confidence intervals, or ranked lists of interference sources or mitigation strategies, among other non-limiting examples. Scoring functions can incorporate weighting factors specified by system operators, organizational policies, or supervisory input, such as potentially derived from knowledge graphs, internal guidelines, or user-defined constraints. Ranking mechanisms may generate ordered lists of candidate mitigation actions or interference sources, optimized according to multiple objectives such as effectiveness, safety, compliance, or operational priorities. In some implementations, ensemble scoring techniques may be employed, where outputs from multiple models are weighted and combined to produce a final prioritized list of mitigation strategies or interference sources, thereby enhancing decision accuracy and robustness.

Furthermore, AI/ML modeling is further adapted to enhance intelligible understanding and guide usage of output. Model interpretability may be enhanced using feature attribution methods (e.g., LIME), attention visualizations, or surrogate models, among other examples. Outputs may be accompanied by context, descriptions, explanations, etc. that indicate the most significant contributing factors or features, provide comparative analysis, suggestions, recommendations, etc. Human-in-the-loop feedback may be incorporated, enabling iterative retraining and calibration of model behavior. Fairness and bias-mitigation techniques may be employed, including re-weighting, counterfactual fairness testing, or adversarial debiasing.

Moreover, models may be deployed as APIs, microservices, or embedded modules within larger enterprise systems including via widgets, iFrames, etc. Real-time inference engines may support streaming data, while batch inference may be used for periodic or large-scale analysis. Models may be updated dynamically, retrained periodically, or adapted through web-based learning modules (e.g., cloud computing). Furthermore, AI/ML models described herein may be implemented using cloud-based platforms, distributed computing systems, edge devices, or hybrid architectures. Storage may be supported by relational databases, graph databases, data warehouses, or vector databases optimized for embeddings. Moreover, training and modeling may comprise a hybrid approach leveraging additional technologies and capabilities including but not limited to: plural AI/ML models, Parallelization, GPU acceleration, specialized hardware (e.g., TPUs), quantum computing, hybrid quantum/AI-ML solutions may be utilized for efficient training, inference, and acceleration of AI/ML modeling for complex problem solutions. For instance, hybrid AI/ML and quantum computing technology may be integrated and used to solve complex matters such as simulations, encryption, large-scale optimization, among other examples.

The present disclosure is further adapted to enable trained AI/ML models to integrate with data endpoints of applications or systems (including third-party integrations) to collect real-time (or near real-time) signal data, thereby enhancing processing efficiency, accuracy, and the adaptability of AI/ML models for interference detection and mitigation applications. For instance, trained AI models may evaluate data from various endpoints related to system components, sensors, communication channels, and environmental parameters—such as signal metrics, device statuses, system logs, and operational states—to identify interference patterns and sources. This additional signal data analysis can support improved decision-making, determine optimal timing for mitigation actions, automate response processes, generate alerts or notifications, and facilitate data-driven insights for system resilience.

Non-limiting examples of signal data include device-specific telemetry from sensors or communication modules; system and network activity logs; environmental or operational parameter readings; user or operator actions, including past and current activity; application or system usage data; profile information, internal policies, or organizational guidelines; and data from third-party integrations such as external monitoring tools or social media feeds. Analyzing such data collectively can reveal correlations, causal relationships, and contextual states of spectral analysis and interference, enabling more precise detection and targeted mitigation strategies. Telemetric and contextual analysis may be applied to generate determinations about interference sources, severity, and impact, as well as to adapt mitigation responses dynamically. All analysis of signal data, including user-specific or system-specific information, occurs in compliance with applicable privacy regulations and organizational policies. Users may provide consent or opt-in to monitoring activities to improve system performance, interference mitigation, and operational robustness within the platform.

Additionally, the present disclosure may further comprise one or more application/service components configured to manage host applications/services and associated endpoints. The application/service component may be further configured to present, through interfacing with other computer components described herein, an adapted graphical user interface (GUI) that provides user notifications, GUI menus, GUI elements, etc., to manage front-end representation of the present disclosure including the ability to execute processing operations and methods (e.g., computer-implemented methods) described herein. An application/service component may further be configured to manage different versions or representations of the present disclosure that are packaged for user access. For example, a stand-alone version of a role-based mapping management app/service may be providable for access by users. In one instance, this may be a SaaS implementation where organizational users may access services described herein via a tenant (e.g., dedicated or shared). In other examples, the present disclosure may be integrable as a component to interface within an organizational software data platform, for instance, that can further tie into additional organizational data endpoints, among other examples.

In any case, an application/service component further manages respective endpoints associated with individual host applications/services, which have been referenced in the foregoing description. In some examples, an exemplary host application/service may be a component of a distributed software platform (e.g., cloud computing platform) providing a suite of host applications/services and associated endpoints, services, microservices, etc. A distributed software platform is configured to providing access to a plurality of applications/services, thereby enabling cross-application/service usage to enhance functionality of a specific application/service at run-time. For instance, a distributed software platform enables interfacing between a host service related to management of a distributed collaborative canvas and/or individual components associated therewith and other host application/service endpoints (e.g., configured for execution of specific tasks). Distributed software platforms may further manage tenant configurations/user accounts to manage access to features, applications/services, etc. as well access to distributed data storage (including user-specific distributed data storage), and distributed knowledge repositories. Moreover, specific host application/services (including those of a distributed software platform) may be configured to interface with other non-proprietary application/services (e.g., third-party applications/services) to extend functionality including data transformation and associated implementation. Role-based access control (RBAC) may be implemented to manage permissions and privileges for access to data described herein.

An exemplary application/service component is further configured to present, through interfacing with computer processing devices, an adapted GUI that provides user notifications, GUI menus, GUI features, etc. The GUI may comprise interactive components such as GUI elements, dashboards, visualization panels, report generation and management, input fields for receiving user selections and parameters, and feedback, among other examples. The system may further generate and present real-time notifications, alerts, or recommendations to the GUI, including contextualized data insights derived from analytics engines or AI/ML models. Such insights may be rendered as charts, tables, or ranked lists, and may dynamically update in response to new data inputs, user actions, or system-detected events, for example, based on processing of exemplary signal data described herein. A GUI processing layer may further be implemented to support adaptive layouts, prioritization of displayed information based on relevance scores, and customizable notification preferences to enhance usability and decision-making. In further examples, a GUI is generated and adapted to manage AI/ML modeling including administrative features/functionalities and controls as described in the foregoing, all of which may be further created customized, adapted, AI/ML modeling.

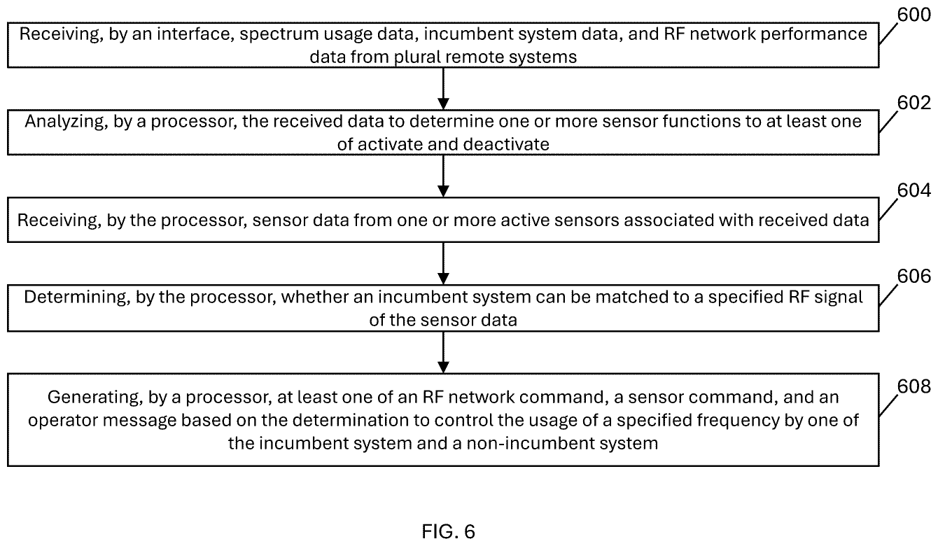

FIG. 6 illustrates a method for mitigating interference in accordance with an exemplary embodiment of the present disclosure. The method can be performed by a computing device configured with a processor running one or more trained ML/AI models for determining interference thresholds and metrics for determining spectrum allocation and/or sharing and defining incumbent waveforms that require protection and actives one or more sensors recognize specific waveforms for over the air (OTA) detection and characterization. Step 600 of the method includes receiving, by an interface, spectrum usage data, incumbent system data, and RF network performance data from plural remote systems. The core network can also be connected to governmental and/or third-party platforms through one or more specified networks. These platforms include information such as spectrum assignments for incumbent systems. The DU 106 can also receive mission planning information such as activations of in-band and IIC events initiated by an entity and GFE sensor data from SIS-Edge/Core or other systems at test and training ranges and receive cueing data on possible interference events from 5G RAN KPI monitoring. The received data can be communicated to the DU 106 over one or more private and/or public networks.

In Step 602, the core network analyzes the received data to determine one or more sensor functions to at least one of activate and deactivate. For example, based on the analysis, the system can define incumbent waveforms that require protection and activate one or more sensors recognize specific waveforms for OTA detection and characterization. The core network receives sensor data from one or more active sensors associated with received data via the RF Sensing 123. Based on the analysis, the system can define incumbent waveforms that require protection and activate one or more sensors recognize specific waveforms for OTA detection and characterization. For example, the core network can receive data signals and associate information from the RF frontend 200 over a fronthaul interface 110. The sensors can be activated to obtain data in specific areas related to the incumbent systems or radio spectrum associated with an incumbent system. Step 604 includes determining whether an incumbent system can be matched to a specified RF signal of the sensor data. The DU 106, then generates at least one of an RF network command, a sensor command, and an operator message based on the determination to control the usage of a specified frequency by one of the incumbent system and a non-incumbent system. For example, commands can be sent to a 5G network to monitor network compliance, monitor unauthorized activity, and notify operators based on the monitoring results.

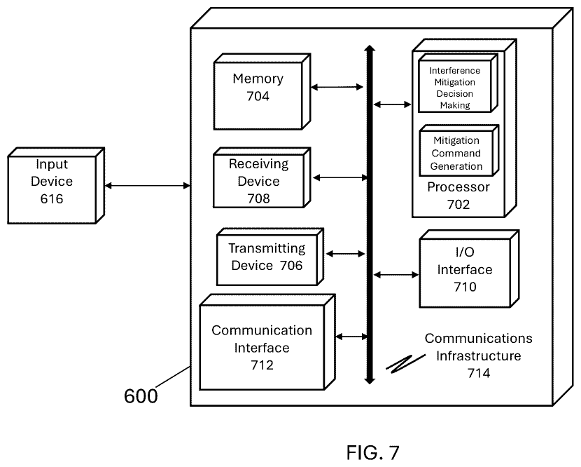

FIG. 7 illustrates a hardware configuration of a computing device in accordance with an exemplary embodiment of the present disclosure. As shown in FIG. 7, the computing system/device 700 of the core network 116 may include a processor (e.g., CPU) 702, memory 704, a transmitting device 706, a receiving device 708, an input/output (I/O) interface 710, a communication infrastructure 712. The processor 702 may execute software instructions (e.g., program code) for mitigating interference in a radio network. The computing system/device 700 as disclosed herein can be configured for training one or more machine learning and/or artificial intelligence models in combination with the software instructions.

The processor 702 may be implemented in hardware, software, or a combination of hardware and software. For example, the processor 702 may include a Reduced Instruction Set Core (RISC) processor, a CISC microprocessor, a Microcontroller Unit (MCU), a CISC-based Central Processing Unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed and/or execute software instructions to perform a function. The hardware of such devices may be integrated onto a single substrate (e.g., silicon “die”) or distributed among two or more substrates. Various functional aspects of the processor 702 may be implemented solely as software or firmware associated with the processor 702. The processor can receive RF signals and data from remote platforms, process them using AI/ML models, and analyze the signals for various purposes such as signal identification and/or classification, and for performing interference mitigation decision making and command generation.

The memory 704 component provides temporary storage for data and instructions that the processor needs during operation. It includes RAM (Random Access Memory) that allows rapid access to data and facilitates smooth execution of complex AI/ML algorithms. The transmitting device 706 and receiving device 708 are communication modules that enable the device to send and receive data over wireless or wired channels. For example, the receiving device 708 might capture RF signals from remote sensors or platforms, while the transmitting device 706 sends processed data or alerts to other systems or operators.

The I/O interface 710 and communication interface 712 acts as a bridge between the internal components of the device and external peripherals or networks.. The input device 714, such as a keyboard, touchscreen, or specialized RF signal input module, allows operators or sensors to provide commands or raw data to the device. The communication interface 712, which could include Ethernet, Wi-Fi, or cellular modules, facilitates network connectivity for data transmission and remote control.

In the context of exemplary embodiments of the present disclosure, the processor 702 can include one or more modules or engines configured to perform the functions of the exemplary embodiments described herein. Each of the modules or engines may be implemented using hardware and, in some instances, may also utilize software, such as corresponding to program code and/or programs stored in memory. In such instances, program code may be interpreted or compiled by the respective processors (e.g., by a compiling module or engine) prior to execution. For example, the program code may be source code written in a programming language that is translated into a lower-level language, such as assembly language or machine code, for execution by the one or more processors and/or any additional hardware components. The process of compiling may include the use of lexical analysis, preprocessing, parsing, semantic analysis, syntax-directed translation, code generation, code optimization, and any other techniques that may be suitable for translation of program code into a lower-level language suitable for controlling the system to perform the functions disclosed herein. It will be apparent to persons having skill in the relevant art that such processes result in the system being a specially configured computing device uniquely programmed to perform the functions of the exemplary embodiments described herein.

It will be appreciated by those skilled in the art that the present disclosure can be embodied in other specific forms without departing from the spirit or essential characteristics thereof. The presently disclosed embodiments are therefore considered in all respects to be illustrative and not restrictive. The scope of the disclosure is indicated by the appended claims rather than the foregoing description, and all changes that come within the meaning, range, and equivalence thereof are intended to be embraced therein.

What is claimed is:

1. A computer-implemented method for mitigating interference on a radio network, the method comprising:
receiving, by an interface, spectrum usage data, incumbent system data, and RF network performance data from plural remote systems;
analyzing, by a processor, the received data to determine one or more sensor functions to at least one of activate and deactivate;
receiving, by the processor, sensor data from one or more active sensors associated with received data;
determining, by the processor, whether an incumbent system can be matched to a specified RF signal of the sensor data; and
generating, by a processor, at least one of an RF network command, a sensor command, and an operator message based on the determination to control the usage of a specified frequency by one of the incumbent system and a non-incumbent system.

2. The computer-implemented method according to claim 1, wherein activating the one or more sensors comprises:
activating at least one of the one or more sensors to an incumbent frequency based on the received data.

3. The computer-implemented method according to claim 2, comprising:
prompting at least one of the activated sensors to a predicted incumbent frequency based on the received data to increase a likelihood of detection.

4. The computer-implemented method according to claim 1, comprising:
analyzing the received sensor data for RF signal identification and RF signal measurement.

5. The computer-implemented method according to claim 1, comprising:
determining whether a valid incumbent system should be protected on the specified frequency based on received sensor data.

6. The computer-implemented method according to claim 1, comprising:
determining whether a non-incumbent system is interfering or has a potential to interfere with the specified frequency of an incumbent system; and
generating the operator message when the non-incumbent system is or has a likelihood to interfere with the specified frequency of the incumbent system.

7. A system for mitigating interference on a radio network, the system comprising:
memory configured to store programming code for controlling spectrum usage among incumbent and non-incumbent systems;
a processor configured to execute the programming code stored in memory, the programming code causing the processor to be further configured to:
receive spectrum usage data, incumbent system data, and RF network performance data from plural remote systems;
analyze the received data to determine one or more sensor functions to at least one of activate and deactivate;
receive sensor data from one or more active sensors associated with received data;
determine whether an incumbent system can be matched to a specified RF signal of the sensor data; and
generate at least one of an RF network command, a sensor command, and an operator message based on the determination to control the usage of a specified frequency by one of the incumbent system and a non-incumbent system.

8. The system according to claim 7, wherein the processor is configured to:
activate at least one of the one or more sensors to an incumbent frequency based on the received data.

9. The system according to claim 8, wherein the processor is configured to:
prompt at least one of the activated sensors to a predicted incumbent frequency based on the received data to increase a likelihood of detection.

10. The system according to claim 7, wherein the processor is configured to:
analyze the received sensor data for RF signal identification and RF signal measurement.

11. The system according to claim 7, wherein the processor is configured to:
determine whether a valid incumbent system should be protected on the specified frequency based on received sensor data.

12. The system according to claim 7, wherein the processor is configured to:
determine whether a non-incumbent system is interfering or has a potential to interfere with the specified frequency of an incumbent system; and
generate the operator message when the non-incumbent system is or has a likelihood to interfere with the specified frequency of the incumbent system.

13. The system according to claim 7, wherein the processor is configured to:
receive the spectrum usage data, the incumbent system data, and the RF network performance data from plural remote systems over one or more application program interfaces.

14. The system according to claim 7, wherein the network performance data includes key performance indicators associated with at least one mobile network operator.

15. The system according to claim 7, wherein the processor is configured to:
receive RF data from a radio access network; and
analyze the RF data to generate key performance analytics.

16. The system of claim 7, wherein processor is configured to:
train a machine learning model for interference detection using the spectral usage data and incumbent system data received from the plural remote systems.

17. The system of claim 7, wherein the processor is configured to:
generate a control signal to selectively activate RF sensors to capture data of the incumbent over the air signals.

18. The system of claim 17, wherein the processor is configured to:
cue the activated RF sensors to expected frequencies for increasing a probability of detection of the incumbent over the air signals.

19. The system of claim 7, wherein the processor is configured to:
obtain mission plan information from the plural remote sources; and
control access to incumbent over the air signals based on the mission plan information.

20. A non-transitory computer readable medium storing executable instructions which cause a processor to:
receive spectrum usage data, incumbent system data, and RF network performance data from plural remote systems;
analyze the received data to determine one or more sensor functions to at least one of activate and deactivate;
receive sensor data from one or more active sensors associated with received data;
determine whether an incumbent system can be matched to a specified RF signal of the sensor data; and
generate at least one of an RF network command, a sensor command, and an operator message based on the determination to control the usage of a specified frequency by one of the incumbent system and a non-incumbent system.
